(19) United States
(12) Patent Application Publication
(10) Pub. No.: US 2017/0320481 A1
(43) Pub. Date: Nov. 9, 2017

(54) A HYBRID VEHICLE AND A METHOD FOR ENERGY MANAGEMENT OF A HYBRID VEHICLE

(71) Applicant: VOLVO TRUCK CORPORATION, S-405 08 Goteborg (SE)

(72) Inventors: Lars JOHANNESSON MARDH, S-423 51Torslarsda (SE); Nikolce MURGOVSKI, Goteborg (SE)

(73) Assignee: VOLVO TRUCK CORPORATION, S-405 08 Goteborg (SE)

(21) Appl. No.: 15/524,300

(22) PCT Filed: Nov. 6, 2014
(86) PCT No.: PCT/EP2014/025012

§ 371 Date: May 4, 2017

(51) Int. Cl. B60W 20/15; B60W 10/08; B60L 11/18; B60W 10/24; B60L 3/00

(52) U.S. Cl. CPC B60W 20/15; B60W 10/24; B60L 3/0046; B60L 11/1887; B60W 10/08

(57) ABSTRACT

A hybrid vehicle includes a drive train, an electrical energy source coupled to the drive train and electrically connected to an electric energy storage device having a state-of-charge, and a non-electrical energy source coupled to the drive-train. A convexification model for the vehicle is used for determining at least one control parameter for operating the vehicle. By applying a convex approach for forming the at least one control parameter it is possible to be sure that the at least one control parameter in fact is a presently optimized parameter. Furthermore, the convex approach minimizes the computational resources necessary for determining the at least one control parameter. The use of a minimal amount of computational resources is specifically desirable in relation to a vehicle on-board solution, typically implementing real-time, continuous, calculations of the at least one control parameter. A corresponding method and computer program product are also provided.

### BACKGROUND AND SUMMARY

The invention generally relates to a method for energy management of a vehicle, and specifically to a hybrid vehicle comprising means for real-time determination of an optimal operation of the vehicle. The invention also relates to corresponding computer implemented method and to a computer program product.

Recent advances in vehicle navigation allow further information than just displayable map data to be provided for use in operating the vehicle. Such information may for example include information about road topography, speed limits for a specified road segment, etc. This additional information may be useful for improving the energy efficiency for operating such a vehicle, and may be specifically useful in relation to a hybrid vehicle including two power sources that are operatively connectable to a drive wheel to propel the vehicle.

Typically, one of the power sources is an engine and another of the power sources is an electric motor. The engine converts the chemical energy in a fuel, e. g. diesel, to mechanical energy through the process of combustion. The electric motor converts electrical energy from e. g. a battery to mechanical energy.

The energy efficiency of vehicles may typically be seen as depending on the energy management strategy currently being applied, i. e. the distribution of power to be delivered in a certain horizon in front of the vehicle. The horizon can be regarded as a moving window that stretches from the current vehicle position to a certain position that lies on the predicted future trajectory of the vehicle. Within the horizon the vehicle is able to acquire preview information as mentioned above (e. g. road topography and speed limit), as well as a desired travel time to reach the final position within the horizon.

Besides the obvious feasible solution where the vehicle drives exactly on the speed limits, the goal of the energy management strategy is to find the optimal speed trajectory that minimizes losses, by still respecting the speed limits and desired travel time within the horizon. This can be achieved by optimally distributing vehicle power, e. g. by delivering high power at some instances and storing the energy in a certain buffer, while discharging the buffer at other time instances in the horizon. An example of an energy buffer in a vehicle is the vehicle itself. That is, the vehicle, as a point mass system, may store both kinetic energy, proportional to the square of the vehicle speed, and potential energy, proportional to the road altitude,

The vehicle has also additional buffers, e. g. a fuel tank for storing the fuel, and in regards to a hybrid vehicle also the battery or a super capacitor for providing electrical energy to the electrical motor. The fuel tank is a special type of buffer, in which energy flows only in one direction during vehicle operation, i. e. this buffer can only be discharged.

When dealing with several energy buffers (fuel tank, kinetic buffer, battery), the energy management strategy has to take into account not only the distribution of magnitude of power along the horizon, but also the arbitration of power among the energy buffers. The optimization objective, and/or constraints in the problem, is typically formulated to include fuel consumption, battery degradation, physical limits of components, and penalties for emissions, comfort and driveability.

An exemplary implementation of an energy management strategy for a hybrid vehicle is disclosed in US2010286909. US2010286909 presents a system for selecting an optimized route from a starting location to a predetermined destination, where each of a plurality of route segments of the route are characterized by an energy cost.

The energy management strategy applied in US2010286909 fully focus on maximizing the use of the battery, determining the best route the vehicle can complete without using the engine, and thereby minimizing or estimating fuel consumption. Disadvantageously, such a focus will not always be the optimal manner to operate the vehicle.

Accordingly, it would be desirable to introduce an improved methodology for controlling the selective use of the engine and the electrical motor, where the methodology takes a more flexible approach allowing further parameters relating to the operation of the vehicle to be taken into account, without making the computation too complex.

According to an aspect of the invention, the above is at least partly alleviated by hybrid vehicle, comprising a drive train, an electrical energy source coupled to the drive train and electrically connected to an electric energy storage device having a state-of-charge, a non-electrical energy source coupled to the drive-train, processing circuitry arranged in the hybrid vehicle and adapted to in real-time determine at least one control parameter for operating the vehicle over a defined trip route, and a control system configured to receive the at least one control parameter from the processing circuitry and to control the transfer of energy from the electrical energy source and the non-electrical energy source to the drive train based on the at least one control parameter, wherein the processing circuitry for determining the at least one control parameter is configured to receive information relating to the operation of the vehicle, comprising at least information relating to the defined trip route, the state-of-charge of the electric energy storage device, and an operational speed of the vehicle, determine the at least one control parameter using a convexification model for the vehicle applying a speed to energy transformation and based on the information relating to the operation of the vehicle, and provide the at least one control parameter to the control system.

In accordance to the invention, the expression “convexification model for the vehicle” should be understood to mean a vehicle model that has been created to apply convex optimization techniques and as a solution provide the at least one control parameter. In addition, the vehicle model makes use of a speed to energy transformation, thereby being able to combine different forms of energy sources in the optimization for determining the at least one control parameter.

The vehicle model is further based on at least some information relating to the present and future operation of the vehicle, comprising at least operational information for the vehicle relating the defined trip route for the vehicle, the state-of-charge of the electric energy storage device, and an operational speed of the vehicle. Accordingly, as an input the vehicle mode! receives the operational information, performs a speed to energy transformation as necessary, and as a solution forms the at least one optimized control parameter to be provided to the control system for controlling the transfer of energy from the electrical energy source and the non-electrical energy source to the drive train. The defined trip may for example be provided by a driver of the vehicle using a user interface provided with the vehicle.

By applying a convex approach for forming the at least one control parameter it is possible to be sure that the at least one control parameter in fact is a presently optimized parameter. Furthermore, the convex approach minimizes the computational resources necessary for determining the at least one control parameter. The use of a minimal amount of computational resources is specifically desirable in relation to a vehicle onboard solution, typically implementing real-time, continuous, calculations of the at least one control parameter. Thus, by means of the invention it may in real time, on-board the vehicle, be possible to schedule the charging and discharging of the electric energy storage device, the vehicle speed, the gear, and when to turn off the engine and drive electrically.

Applying a convex approach to determining the at least one control parameter has shown advantageous as compared to real-time implementation of a Dynamic Programming (DP) algorithm. Specifically, DP suffers from the curse of dimensionality, which means that computation time grows exponentially with increased number of dynamic states and control signals. With the advent of hybrid electric heavy-duty trucks, this impediment is emphasized, since the control algorithm will have to coordinate both the kinetic and electric energy of the vehicle.

In a preferred embodiment of the invention the at least one control parameter comprises at least one of a state and a costate to be used with a control policy applied by the control system. The provision of both a state and a costate allows for the possibility to define the at least one control parameter in more than one way. Such a possibility may for example allow for the state to define a control variable and the costate to define the cost of using the control variable. This will be further elaborated below.

The state may preferably comprise at least one of a vehicle speed, a state of charge for the electrical energy storage device, a state of health for the energy storage device, an operational state for the electrical energy source, and an operational state for the non-electrical energy source. Further control variables may be possible and are within the scope of the invention. In a similar manner, costates relating to the mentioned states are possible, and may in some instances define a cost relating to the state variable.

The convex vehicle model is preferably adapted to predict an optimized use of the electrical energy source and the non-electrical energy source for the defined trip route.

Advantageously, having prior knowledge of the trip the vehicle is taking (or is about to take), it may be possible, in accordance to the invention, to optimize the distribution and use of the different energy sources for propelling the vehicle. The vehicle model is, as indicated above, adapted to also determine a cost relating to usage of the different energy sources. As such, it may be possible to not only maximize the use of e. g. the electrical energy source, e. g. a battery, but rather further take into account the cost of doing so. Thereby, different considerations may be made, for example when also the cost of using the battery may be reviewed. Scenarios may for example exist where wear of the battery may have a serious impact on the selection of using the non-electrical or electrical energy source.

Preferably, the non-electrical energy source is an internal combustion engine (ICE), connected to a fuel tank holding e. g. a fuel such as diesel or petrol. The electrical energy source is typically an electrical motor, electrically connected to the battery. Further electric energy storage devices may exist, such as for example a supercapacitor. The state-of-charge (SoC) for the energy storage device provides e. g. an indication as to the charging level of the energy storage device.

In an embodiment of the invention, the information relating to the operation of the vehicle further comprise at least one of information as to a current kinetic energy of the vehicle and a topographic profile of the defined trip route. The expression topographic profile should be interpreted broadly and understood to include all type of thereto related data, e. g. altitude and curve related. The topographic profile, for example in combination with the current kinetic energy of the vehicle, may be used for optimizing the operation of the vehicle when e. g. approaching or passing a hill (uphill/downhill). The combination with the current kinetic energy of the vehicle takes the optimization to a further level as it makes it possible to, for example, maximize the entry speed when approaching a hill. It will additionally be desirable to also take into account the current speed limits for the vehicle type at current road segment (i. e. being a portion of the defined trip route, the trip route typically comprising a plurality of connected road segments) where the vehicle is driven.

In addition to a current speed limit for the road segment (trip route), it may further be desirable to have knowledge as to a current speed of the vehicle, a desired average speed of the vehicle and a speed interval for the vehicle. Advantages with having knowledge and making use of this information in relation to determining the at least one control parameter will make it possible to optimize the operation for minimizing any jerk in driving the vehicle, making the operation more pleasant for the driver of the vehicle.

In an embodiment, the at least one control parameter is further determined based on a predetermined cruise gear for the vehicle. It is typically desirable to optimize the vehicle to use the highest gear, thereby reducing the power consumption for operating the vehicle.

It is desirable if the at least one control parameter is defined over a time period, thereby forming a reference trajectory to be applied by the control system. By not only determining an e. g. numerical value for the at least one control parameter, but rather a reference trajectory to be used for controlling the vehicle, the control system may be provided with an at least short horizon as to how to control the vehicle. Also this will allow for a smoother operation of the vehicle, possibly requiring less gear shifts and reduced usage of the braking pads, since information of future operation may be taken into account when controlling the vehicle.

In a preferred embodiment of the invention, the control system is further configured to receive the reference trajectory and a current operational state of the vehicle and output an adapted state reference to be applied by the control system. As such, the at least one control parameter determined by the processing circuitry may be adapted by a feedback signal typically relating to the current operational state of the vehicle. Thus, a constant adjustment may be made to the control parameter to better correspond to the current operation of the vehicle.

According to another aspect of the present invention there is provided a computer implemented method for determining at least one control parameter for operating a hybrid vehicle, the hybrid vehicle, comprising a drive train, an electrical energy source coupled to the drive train and including an electric energy storage device having a state-of-charge, a non-electrical energy source coupled to the drive-train, and a control system configured to control the transfer of energy from the electrical energy source and the non-electrical energy source to the drive train based on the at least one control parameter, wherein the method comprises the steps of receiving information relating to the operation of the vehicle, comprising at least information relating to the defined trip route, the state-of-charge of the electric energy storage device, and an operational speed of the vehicle, determining the at least one control parameter using a convexification model for the vehicle applying a speed to energy transformation and based on the information relating to the operation of the vehicle, and providing the at least one control parameter to the control system. This aspect of the invention provides similar advantages as discussed above in relation to the previous aspect of the invention.

According to a still further aspect of the present invention there is provided a computer program product comprising a computer readable medium having stored thereon computer program means for determining at least one control parameter for operating a hybrid vehicle, the hybrid vehicle comprising a drive train, an electrical energy source coupled to the drive train and including an electric energy storage device having a state-of-charge, a non-electrical energy source coupled to the drive-train, and a control system configured to control the transfer of energy from the electrical energy source and the nonelectrical energy source to the drive train based on the at least one control parameter, wherein the computer program product comprises code for receiving information relating to the operation of the vehicle, comprising at least information relating to the defined trip route, the state-of-charge of the electric energy storage device, and an operational speed of the vehicle, code for determining the at (east one control parameter using a convexification model for the vehicle applying a speed to energy transformation and based on the information relating to the operation of the vehicle, and code for providing the at least one control parameter to the control system. Also this aspect of the invention provides similar advantages as discussed above in relation to the previous aspects of the invention.

The computer readable medium may be any type of memory device, including one of a removable nonvolatile random access memory, a hard disk drive, a floppy disk, a CD-ROM, a DVD-ROM, a USB memory, an SD memory card, or a similar computer readable medium known in the art.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

The various aspects of the invention, including its particular features and advantages, will be readily understood from the following detailed description and the accompanying drawings, in which:

FIG. 1a illustrates a hybrid vehicle equipped with an on-board control unit for determining at least one control parameter in accordance to a currently preferred embodiment of the invention;

FIG. 1b shows an exemplary drive train structure adapted in accordance to an embodiment of the invention;

FIG. 2 provides an illustration of an on-board control arrangement according to a currently preferred embodiment of the invention; and

FIG. 3 depicts method steps applied by the on-board control arrangement shown in FIG. 2.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

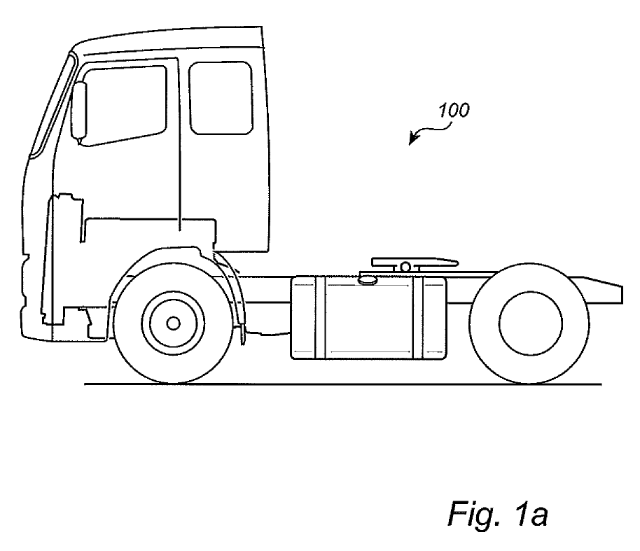

Referring now to the drawings and to FIGS. 1a and 1b in particular, there is depicted an exemplary hybrid vehicle, here illustrated as a truck 100. The truck 100 is provided with a first 102 and a second 104 source of motive power for propelling the truck 100 via a driveline 106 connecting the power sources 102, 104 to a set of wheels 108. The first power source is constituted by an internal combustion engine (ICE) 02 in the form of a diesel engine connected to a fuel tank 110. It will in the following, for ease of presentation, be referred to as an internal combustion engine 102. The second power source is constituted by an electrical motor 104, powered by an electric energy storage device, such as a rechargeable battery 112. Those skilled in the art will recognize a variety of battery configurations that may be employed within the scope of the claimed invention, such as lead-acid, lithium-ion, nickel-cadmium, nickel-metal hydride, etc. As used herein, a “battery” may include multiple batteries or cells operatively interconnected, e. g., in series or in parallel, to supply electrical energy.

The truck 100 further comprises a generator (not explicitly shown). The generator is selectively connected to the drivetrain 106 to drive the generator, which causes the generator to generate electrical energy, as understood by those skilled in the art. The generator is operatively connected to the battery 112 to supply electrical energy thereto for recharging the battery 12. An on-board control arrangement 114 controls the transfer of energy from the energy sources 102, 104 to the drivetrain 106, as well as the flow of energy between the drivetrain 106 and the generator for recharging the battery 112, depending on at least one control command provided by the on-board control arrangement, etc.

In the exemplifying embodiment illustrated in FIG. 1 b, the truck 100 employs a parallel drivetrain structure, optionally configured to allow the battery 112 to be rechargeable by an off-board electrical source (such as the electric grid). In addition, it should be understood that the hybrid truck 100 also may employ regenerative braking, meaning that for example the electrical motor 104 may be employed to act as a generator for charging the battery 112, for example when breaking the truck 100 when travelling down a steep hill, etc. Within the scope of the claimed invention, the hybrid truck 100 may alternatively be configured to employ a series drivetrain structure.

The on-board control arrangement 114 may include a general purpose processor, an application specific processor, a circuit containing processing components, a group of distributed processing components, a group of distributed computers configured for processing, etc. The processor may be or include any number of hardware components for conducting data or signal processing or for executing computer code stored in memory. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e. g., via a circuit or any other wired, wireless, or network connection) and includes computer code for executing one or more processes described herein.

The on-board control arrangement 114 may also be connected to e. g. a communication interface (such as e. g. a CAN bus or similar, or a dedicated communication interface) of the truck 100, preferably for allowing control of elements of the truck 100, such as for example to control gear shifting, braking and gas pedals and the on/off state of the internal combustion engine (ICE) of the truck 100.

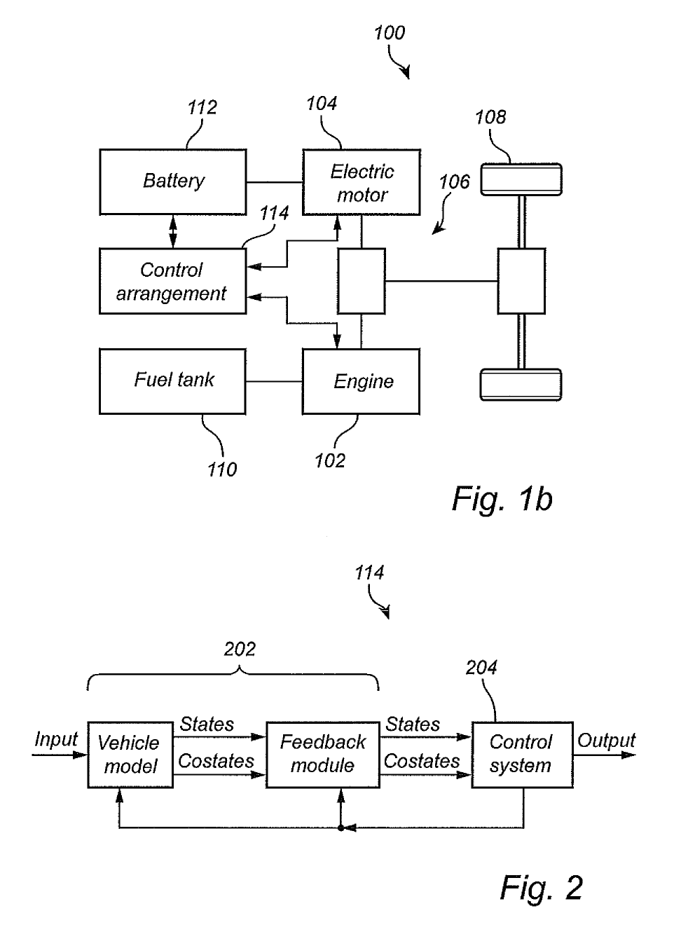

Turning now to FIG. 2 which provides a detailed illustration of the on-board control arrangement 114, provided for controlling the energy transfer for the hybrid vehicle shown in FIGS. 1a and 1b. The on-board control arrangement 114 comprises processing circuitry 202 and a control system 204, working together for controlling the transfer of energy from the ICE 102 and the electrical motor 104 to the drive train 106. Generally, the processing circuitry 202 determines at least one control parameter and the control system 204 adapts the at least one control parameter based on a feedback signal defining a current operational state of the truck 100. Thus, a constant adjustment may be made to the at least one control parameter to better correspond to the current operation of the truck 100.

The processing circuitry 202 is configured to receive general operational information relating to the truck 100. Such information includes information relating to a defined trip route to be taken by the truck 100, a state-of-charge of the battery 108, and an operational speed of the truck 100. This information may be received, from for example, a GPS receiver (not shown) and from information received from a navigation system (not shown) provided with the truck 100. The navigation system may be connected to the processing circuitry 202 using the CAN bus. It should be noted that the processing circuitry 202 and the control system 204 both may be implemented as one entity, in software, hardware and a combination thereof. It may also be possible to implement the processing circuitry 202 and the control system 204 as separate entities, in communication with each other. The processing circuitry 202 and the control system 204 may be implemented, e. g. distributed within the truck 100, such as within one or a plurality of engine control units (ECU) of the truck 100.

Information received from the navigation system may for example comprise topographical data for the defined trip, including information as to altitude variations over the defined trip, as well as information relating to curves, road surfaces, etc. Further information may typically be included, such as speed limits for segments of the defined trip route. The term speed limit should be interpreted broadly and may include both a maximum and a minimum speed for the different road segments. Accordingly, the expression “operational speed of the vehicle” may be defined as the desired speed of the vehicle at a segment of the defined trip route.

The processing circuitry 202 implements an abstraction of a vehicle model that accurately represents the vehicle mode! about a given set speed, e. g. defined by the information provided by the navigation system, and cruise gear for use in propelling the truck 100. The vehicle model applied by the control architecture is a convex model that has been adapted to work with the vehicle's kinetic energy rather that being based on the speed of the truck 100. In addition, the vehicle model samples based on distance traveled by the truck 100 rather than based on time.

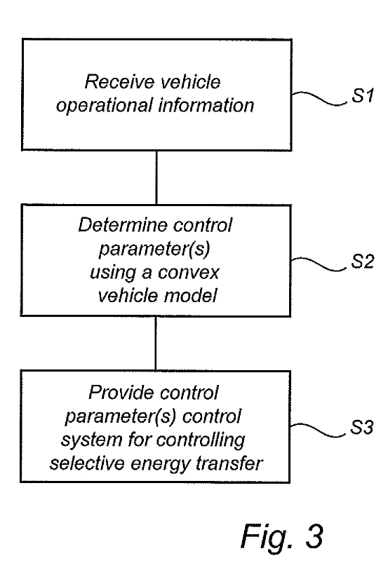

With further reference to FIG. 3, the vehicle model receives, S1, the general operational information for the truck 100 and determined, S2, the at least one control parameter. The at least one control parameter may in turn typically comprise a state and a costate, expressions that may be recognized from the technical area of optimal control, in relation to the present invention, the state and the costate provided from the vehicle model are defined over a time period, forming a reference trajectory for each of the state and the costate.

The processing circuitry 202 typically also comprises a feedback module to allow adjustments of the reference trajectories for each of the state and the costate based on feedback from control system 204 controlling the truck 100. The feedback from the control system 204 typically comprise information relating to the current operational state of the truck 100, such as the current speed of the truck 100, the current SoC for the battery 112, aging level of the battery 112, speed limit for the current road segment, etc.

It should be noted that the processing circuitry 202 and the control system 204 may be allowed to operate on “different time scales”. For example, the processing circuitry 202 and the control system 204 may apply different sampling frequencies. In addition, it may in accordance to the invention be possible to allow the processing circuitry 202 and the control system 204 to sample based on different scales, such as allowing the processing circuitry to sample (form an updated reference trajectory for each of the state and the costate) based on a distance traveled for the truck 100, such as forming new parameters once every kilometre traveled by the truck 100, while the control system 204 samples as a time scale, such as with a 20 Hz sampling rate. The sampling rates (distance/time) as presented above are just examples and other sampling rates are possible and within the scope of the invention.

The state and the costate having been adjusted by the feedback module are typically adjusted for providing, S3, a state reference and a costate reference to be applied by the control system 204. The state reference may be seen as a set-point for a control policy applied by the control system 204. Thus, the control system 204 may act independently of the processing circuitry 202. The costate reference will typically indicate a cost relating to the state reference. As such, the control system 204 may also take this information into account when controlling the operation of the truck 100.

Furthermore, by dividing the control problem handled by the on-board control arrangement 114 into two layers (i. e. the processing circuitry 202 and the control system 204) that operate with different update frequencies and prediction horizons, the top layer (i. e. the processing circuitry 202) may be adapted to plan the kinetic and electric energy as a convex optimization problem. In addition, in order to avoid a mixed-integer problem, the gear and the switching decision between hybrid and pure electric mode may be optimized in the lower layer (i. e. the control system 204) in a dynamic program.

With further reference to the vehicle model forming part of the processing circuitry 202, a plurality of steps and approximations are performed in order to obtain a convex optimization problem, including constraining the trip time to not be greater than a given travel time, or by constraining kinematic energy to not be less than a given mean energy.

This may typically be defined as:

$${\sum }_{k = 1}^{N} \frac{{s}_{d}}{\sqrt{2 E ( k ) / m}} \leq {T}_{trip} \\ ( Nonlinear convex constraint ) , or$$

$${\sum }_{k = 1}^{N} E ( k ) \geq {E}_{total} \\ ( Linear convex constraint )$$

where E(k) is the vehicle kinematic energy, m is the vehicle mass, sd is the sampling distance,k is the sample index, N is the total number of samples, Ttrip the required time to travel the distance Nsd (being a product), and Etotal is the total kinematic energy when travelling at the average speed required to keep the trip time.

Furthermore, it is desirable to:
Approximate the power limits of the powertrain components (engine, electric machine, battery, etc.) as affine force limits in kinetic energy obtained by linearizing around the set speed, for example provided by a driver of the vehicle (the average speed required to keep the trip time).
Model the longitudinal force as a sum of three contributions:

I. Force delivered on cruise gear constrained by the engine maximum force on cruise gear.

II. Remaining force delivered from the engine for any lower admissible gear, constrained by the engine maximum power that can be delivered at the set speed.

III. Force of the hybrid system constrained by the total maximum force, engine and electric machines, on cruise gear.
Approximate engine losses with two distinct constant marginal efficiencies, one for the force that can be delivered on cruise gear and one lower marginal efficiency for the remaining force delivered at lower gears. This is a convex model that encourages operation at cruise gear. Friction losses are modeled as convex in kinetic energy.
Model losses of powertrain components (electric machine, battery, etc.), except the engine, as convex functions in delivered force and vehicle's kinetic energy. Non-convex component models are approximated as convex about the set speed, and
Relax component losses by letting powertrain components throw away energy.

Further relaxations and approximations in regards to the convex vehicle model is possible and within the scope of the invention. In addition, within the scope of the invention it is desirable to emphasis on the fact that the above disclosed hierarchical decentralized control scheme with corresponding predictive control algorithms for coordinated control of the kinetic and electric energy buffers in a hybrid vehicle is made possible based on the vehicle modelling steps that enable the use of convex optimization. The convex optimization allows for fuel saving potential of coordinated use of the kinetic and electric energy buffer, whereas the low computational requirements mean that the control scheme can be implemented on currently available electronic control units.

Being able to plan the kinetic and electric energy buffers in a convex optimization problem opens up the possibility of expanding the predictive controller with even more dynamic states. This may for example allow for control schemes with models of surrounding traffic as well as control schemes and convex optimizations to minimize the fuel consumption of a vehicle platoon with several conventional and hybrid vehicles.

In summary, the present invention relates to hybrid vehicle, comprising a drive train, an electrical energy source coupled to the drive train and including an electric energy storage device having a state-of-charge, a non-electrical energy source coupled to the drive-train. In accordance to the invention, a convexification model for the vehicle is used for determining at least one control parameter for operating the vehicle. By applying a convex approach for forming the at least one control parameter it is possible to be sure that the at least one control parameter in fact is a presently optimized parameter. Furthermore, the convex approach minimizes the computational resources necessary for determining the at least one control parameter. The use of a minimal amount of computational resources is specifically desirable in relation to a vehicle on-board solution, typically implementing realtime, continuous, calculations of the at least one control parameter.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor.

By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. Additionally, even though the invention has been described with reference to specific exemplifying embodiments thereof, many different alterations, modifications and the like will become apparent for those skilled in the art.

Variations to the disclosed embodiments can be understood and effected by the skilled addressee in practicing the claimed invention, from a study of the drawings, the disclosure, and the appended claims. Furthermore, in the claims, the word “comprising” does not exclude other elements or steps, and the indefinite article “a” or “an” does not exclude a plurality.

1. A hybrid vehicle, comprising:
a drive train;
an electrical energy source coupled to the drive train and electrical connected to an electric energy storage device having a state-of-charge;
a non-electrical energy source coupled to the drive-train;
processing circuitry arranged in the hybrid vehicle and adapted to in real-time determine at least one control parameter for operating the vehicle over a defined trip route, wherein the control parameter is provided for controlling the transfer of energy from the electrical energy source and the non-electrical energy source to the drive train, and
a control system configured to receive the at least one control parameter from the processing circuitry and to control the transfer of energy from the electrical energy source and the non-electrical energy source to the drive train based on the at least one control parameter,
wherein the processing circuitry for determining the at least one control parameter is configured to:
receive information relating to the operation of the vehicle, comprising at least information relating to the defined trip route, the state-of-charge of the electric energy storage device, and an operational speed of the vehicle;
determine the at least one control parameter based on the vehicle's kinetic energy, wherein the vehicle's kinetic energy is determined using a convexification model for the vehicle applying a speed to energy transformation and based on the information relating to the operation of the vehicle, and
provide the at least one control parameter to the control system.

2. The hybrid vehicle according to claim 1, wherein the at least one control parameter comprises at least one of a state and a costate to be used with a control policy applied by the control system, wherein the state is configured to define a control variable and the costate is configured to define the cost of using the control variable.

3. The hybrid vehicle according to claim 2, wherein the state comprises at least one of a vehicle speed, a state of charge for the electrical energy storage device, a state of health for the energy storage device, an operational state for the electrical energy source, and an operational state for the non-electrical energy source.

4. The hybrid vehicle according to claim 1, wherein the convexification model is adapted to predict an optimized use of the electrical energy source and the non-electrical energy source for the defined trip route.

5. The hybrid vehicle according to claim 1, wherein the information relating to the operation of the vehicle further comprise at least one of information as to a current kinetic energy of the vehicle and a topographic profile of the defined trip route.

6. The hybrid vehicle according to claim 1, wherein the operational speed of the vehicle comprises at least one of a current speed of the vehicle, a desired average speed of the vehicle, a speed interval for the vehicle and a speed limit for the defined trip route.

7. The hybrid vehicle according to claim 1, wherein the at least one control parameter is further determined based on a predetermined cruise gear for the vehicle.

8. The hybrid vehicle according to claim 1, wherein the at least one control parameter is further determined based on a cost for operating the vehicle, including a comparison between operating the vehicle using the electrical energy source and operating the vehicle using the non-electrical energy source.

9. The hybrid vehicle according to claim 1, wherein the at least one control parameter is defined over a time period, forming a reference trajectory to be applied by the control system.

10. The hybrid vehicle according to claim 9, wherein the control system is further configured to receive the reference trajectory and a current operational state of the vehicle and output an adapted state reference to be applied by the control system.

11. A computer implemented method for determining at least one control parameter for operating a hybrid vehicle, the hybrid vehicle comprising:
a drive train;
an electrical energy source coupled to the drive train and electrically connected to an electric energy storage device having a state-of-charge;
a non-electrical energy source coupled to the drive-train, and
a control system configured to control the transfer of energy from the electrical energy source and the non-electrical energy source to the drive train based on the at least one control parameter, wherein the control parameter is provided for controlling the transfer of energy from the electrical energy source and the non-electrical energy source to the drive train, wherein the method comprises the steps of:
receiving information relating to the operation of the vehicle, comprising at least information relating to the defined trip route, the state-of-charge of the electric energy storage device, and an operational speed of the vehicle;
determining the at least one control parameter based on the vehicle's kinetic energy, wherein the vehicle's kinetic energy is determined using a convexification model for the vehicle applying a speed to energy transformation and based on the information relating to the operation of the vehicle, and
providing the at least one control parameter to the control system.

12. The method according to claim 11, wherein the at least one control parameter comprises at least one of a state and a costate to be used with a control policy applied by the control system, wherein the state is configured to define a control variable and the costate is configured to define the cost of using the control variable.

13. The method according to claim 12, wherein the state comprises at least one of a vehicle speed, a state of charge for the electrical energy storage device, a state of health for the energy storage device, an operational state for the electrical energy source, and an operational state for the non-electrical energy source.

14. The method according to claim 11, wherein the convexification model is adapted to predict an optimized use of the electrical energy source and the non-electrical energy source for the defined trip route.

15. The method according to claim 11, wherein the information relating to the operation of the vehicle further comprise at least one of information as to a current kinetic energy of the vehicle and a topographic profile of the defined trip route.

16. The method according to claim 11, wherein the operational speed of the vehicle comprises at least one of a current speed of the vehicle, a desired average speed of the vehicle, a speed interval for the vehicle and a speed limit for the defined trip route.

17. The method according to claim 11, wherein the at least one control parameter is further determined based on a predetermined cruise gear for the vehicle.

18. The method according to claim 11, wherein the at least one control parameter is further determined based on a cost for operating the vehicle, including a comparison between operating the vehicle using the electrical energy source and operating the vehicle using the non-electrical energy source.

19. The method according to claim 11, wherein the at least one control parameter is defined over a time period, forming a reference trajectory to be applied by the control system.

20. The method according to claim 19, further comprising the step of receiving the reference trajectory and a current operational state of the vehicle, and output an adapted state reference to be applied by the control system.

21. Computer program product comprising a non-transitory computer readable medium having stored thereon a computer program for determining at least one control parameter for operating a hybrid vehicle, the hybrid vehicle comprising a drive train, an electrical energy source coupled to the drive train and electrically connected to an electric energy storage device having a state-of-charge, a non-electrical energy source coupled to the drive-train, and a control system configured to control the transfer of energy from the electrical energy source and the non-electrical energy source to the chive train based on the at least one control parameter, wherein the control parameter is provided for controlling the transfer of energy from the electrical energy source and the non-electrical energy source to the drivetrain, wherein the computer program product comprises:
code for receiving information relating to the operation of the vehicle, comprising at least information relating to the defined trip route, the state-of-charge of the electric energy storage device, and an operational speed of the vehicle;
code for determining the at least one control parameter based on the vehicle's kinetic energy, wherein the vehicle's kinetic energy is determined using a convexification model for the vehicle applying a speed to energy transformation and based on the information relating to the operation of the vehicle, and
code for providing the at least one control parameter to the control system.
